(19) United States
(12) Patent Application Publication
(10) Pub. No.: US 2006/0170379 A1
(43) Pub. Date: Aug. 3, 2006

(54) Vehicle headlamp

(75) Inventor: Naoki Uchida, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD.

(21) Appl. No.: 11/344,070

(22) Filed: Feb. 1, 2006

(30) Foreign Application Priority Data
Feb. 1, 2005 (JP) 2005-025019

(51) Int. Cl. H05B 39/00

(52) U.S. Cl. 315/312

(57) ABSTRACT

A vehicle headlamp 1 includes a first lamp unit 2A which employs a discharge lamp 3 as a light source, and a second lamp unit 2B which employs a semiconductor light-emitting element 5 as a light source. Lighting of the first and second lamp units is started substantially simultaneously, and, in conjunction therewith, the second lamp unit 2B is lit during a period until the discharge lamp 3 has transitioned to a steady lighting state. Thus, insufficient luminous energy during the transient period is complemented. Illumination light patterns originating from a plurality of lamp units are superimposed, thereby obtaining a low-beam light distribution.

This application claims foreign priority from Japanese Patent Application No. 2005-025019, filed Feb. 1, 2005, the entire disclosure of which is herein incorporated by reference.

### BACKGROUND OF THE INVENTION

1. Field of the Invention

The present invention relates to a vehicle headlamp which employs, as alight source, a lamp unit including a semiconductor light-emitting element, such as a light-emitting diode, and a discharge lamp. Because the semiconductor light-emitting element has instantaneous lighting, the headlamp can obtain a low-beam light distribution pattern without application of a heavy load during a transient power control.

2. Description of Related Art

It is known to use a vehicle headlamp which employs a plurality of lamp units, each of which employs a light-emitting diode as a light source. A low-beam (dipped-beam) light distribution can be obtained by superimposing light distribution patterns formed by a variety of lamp units differing in optical configuration (see, e.g., Japanese Patent Publication No. 2004-95480).

In addition, in relation to a vehicle headlamp, which employs a high-pressure discharge lamp, such as a metal halide lamp, as a light source, the following are known as methods for improving starting of the discharge lamp.

(A) A method of complementing insufficient luminous energy by lighting an auxiliary light source, such as an incandescent lamp, during a transient period from a startup of a discharge lamp until transition to a stable lighting state;

(B) a method of providing a preheating circuit for a discharge lamp, which performs preheating upon detection of turn-on of a small-lamp switch or decrease in brightness around a vehicle, so as to reduce a time from a startup of a discharge lamp until transition to a stable lighting state (see, e.g., Japanese Utility Model Publication No. 03-30186); and

(C) a method, in relation to transient power control at an early stage of lighting, of temporarily inputting electric power exceeding a rated power of a discharge lamp, thereby expediting light emission from a discharge lamp, and thereafter causing transition to a steady lighting state.

Meanwhile, the above-described methods (A) and (C) create problems, such as the following.

First, method (A) requires provision of an auxiliary light source, such as an incandescent lamp, in addition to a discharge lamp. Therefore, there arise problems, such as high cost, or that the utilization ratio of the light source is low, since lighting of the auxiliary light source is not required after the discharge lamp realizes a stable lighting state. Another conceivable method is to cause a light source of an auxiliary headlamp, such as a fog lamp, to illuminate temporarily, to thereby be employed as a substitute light source. However, this method also involves problems, such as an increase in usage frequency of the light source.

Meanwhile, method (B) is accompanied with concerns about an increase in power consumption caused by preheating, an increase in complexity of a circuit configuration due to addition of a circuit for preheating, increased cost, and the like.

Method (C) induces rapid light emission of the discharge lamp by the transient power control. In this case, the control circuit is complicated in configuration; or, consideration must be given to a structure of a bulb, such as increasing a diameter of an electrode of the bulb. Put another way, in view of influences on a useful life, and the like, power control is preferably performed at a rated power value or within an allowable range centered on the rated power value, even when such power control requires a starting time, which is of at least a certain length, rather than a transient power control through which lighting is started under a condition where an excessive load is applied on the discharge lamp.

Hence, the present invention relates to a vehicle headlamp having a lamp unit which employs a discharge lamp as a light source, and aims at eliminating obstacles against formation of a low-beam light distribution pattern without performing power control, and the like, for shortening a starting time after startup of the discharge lamp through utilization of instantaneous lighting of a semiconductor light-emitting element.

### SUMMARY OF THE INVENTION

The invention is a vehicle headlamp having a first lamp unit which employs a discharge lamp as a light source, and a second lamp unit which employs a semiconductor light-emitting element as a light source. The vehicle head lamp can be configured such that a period of time required for lighting the lamp unit is made shorter than a period of time required from a point in time when lighting of the first and second lamp units is started substantially simultaneously until the discharge lamp has transitioned to a steady lighting state; and illumination light patterns originating from the respective lamp units are superimposed so as to obtain a low-beam light distribution.

Accordingly, when lighting of the first and second lamp units is started, first, the second lamp unit illuminates instantaneously, and thereafter the first lamp unit transitions to the steady lighting state. This obviates an input of power exceeding the rated power during a transient power control period for reducing a starting time of the discharge lamp. In addition, because of fast transition to illumination or nonillumination, a semiconductor light-emitting element is adequate as a light source for complementing insufficient luminous energy during starting of a discharge lamp. Since a low-beam light distribution can be obtained by use of illumination light patterns respectively originating from the first and second lamp units, a problem of a low utilization ratio of the light source does not arise (a light distribution pattern is formed through combined use with the discharge lamp rather than causing the light-emitting element to illuminate temporarily).

### BRIEF DESCRIPTION OF THE DRAWINGS

The advantages, nature and various additional features of the invention will appear more fully upon consideration of the exemplary embodiments of the invention, which are schematically set forth in the drawings, in which:

FIG. 1 is a schematic view illustrating an example basic configuration of a vehicle headlamp according to an exemplary embodiment of the invention;

FIG. 2 is a view illustrating an example configuration of a first lamp unit of the exemplary embodiment;

FIG. 3 is a view illustrating another example configuration of the first lamp unit of the exemplary embodiment;

FIG. 4 is a view illustrating an example configuration of a second lamp unit of the exemplary embodiment;

FIG. 5 is a view illustrating another example configuration of the second lamp unit of the exemplary embodiment;

FIG. 6 is a view schematically illustrating an example configuration of a lamp unit which utilizes light originating from light-emitting diodes and thereafter reflected, showing a vertical cross-section of the configuration;

FIG. 7 is a view schematically illustrating the same, showing a perspective view;

FIG. 8 is a view illustrating an example application of the exemplary embodiment of the invention to a vehicle headlamp, showing a front view of the lamp;

FIG. 9 is a view illustrating the same, schematically showing a low-beam light distribution pattern;

FIG. 10 is a view illustrating another example application of the exemplary embodiment of the invention to a vehicle headlamp, showing a front view of the lamp;

FIG. 11 is a view illustrating the same, schematically showing a low-beam light distribution pattern;

FIG. 12 is a view illustrating an example of the configuration of a lighting circuit;

FIG. 13 is an explanatory view depicting an example configuration of respective lamp units;

FIG. 14 is a graph illustrating an example of changes with time in input power to a discharge lamp;

FIG. 15 is a graph illustrating an example of changes in build-up of a luminous flux of the discharge lamp; and

FIG. 16 is a graph illustrating an example of changes in a luminous flux maintenance factor, where an initial value is assumed to be 100 (%).

### DETAILED DESCRIPTION OF THE EXEMPLARY EMBODIMENTS

Although the invention will be described below with reference to an exemplary embodiment thereof, the following exemplary embodiment does not restrict the invention.

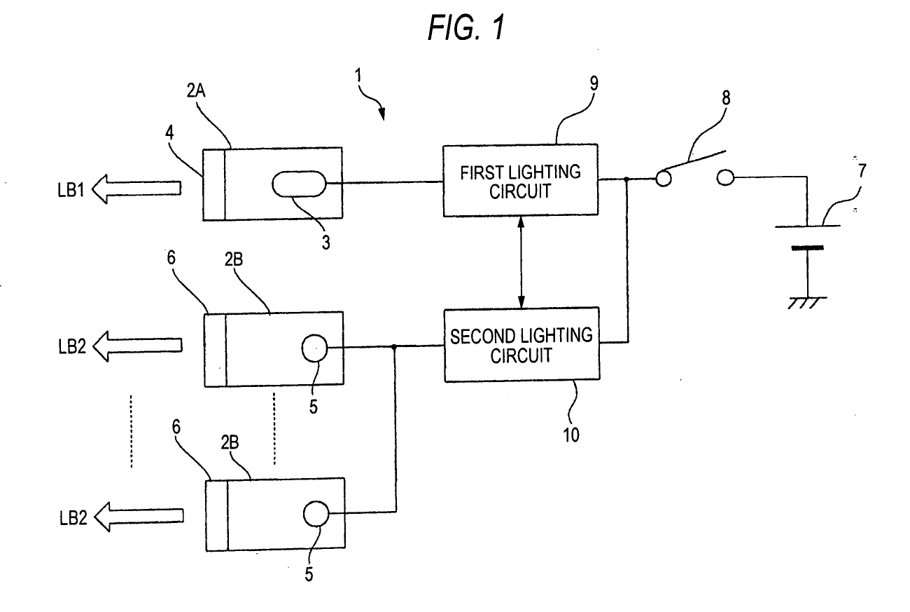

FIG. 1 is a schematic view illustrating a basic configuration of a vehicle headlamp according to an exemplary embodiment of the present invention.

A vehicle headlamp 1 is used when a low beam is to be illuminated, and comprises a plurality of lamp units 2A and 2B. Among the lamp units, the first unit 2A employs a discharge lamp (or a discharge bulb) as a light source; and each of the second lamp units 2B employs a semiconductor light-emitting element, such as a light-emitting diode, as a light source.

An HID lamp (high intensity discharge lamp); e.g., a metal halide lamp, is used as a light source of the first lamp unit 2A. The color temperature of a discharge lamp 3 falls within a range of 4,000 to 5,000 K (kelvin). Generally, a discharge lamp has a high intensity, but requires some time until brightness is stabilized after startup.

The lamp unit 2A has optical members 4 (e.g., a reflection mirror, a lens, and the like) for illuminating light originating from the discharge lamp 3 forward.

A semiconductor light-emitting element 5; e.g., a white light-emitting diode, is used as a light source of each of the second lamp units 2B. The color temperature of the semiconductor light-emitting element 5 falls within a range of 4,000 to 6,500 K. The light-emitting diode has a color temperature close to that of the HID lamp. Therefore, even when a light distribution pattern is formed by superimposing the light originating from the light-emitting diode and the light originating from the discharge lamp, the pattern provides a less unnatural sensation. However, compared with the discharge lamp, the light-emitting diode has a low intensity. Therefore, a plurality of lamp units are required for obtaining a predetermined luminous flux.

Each of the lamp units 2B has optical members 6 (e.g., a reflection mirror, a lens, and the like) for illuminating light originating from the semiconductor light-emitting element 5 forward.

A circuit device for lighting the respective lamp units includes a DC power supply 7, a switch 8, and lighting circuits 9 and 10.

The first lighting circuit 9 is a circuit for lighting the discharge lamp 3 of the fist lamp unit 2A; and in a state; e.g., in which the switch 8 (a lighting switch) closed, the circuit 9 receives a DC input voltage from the DC power supply 7, converts the voltage into an alternating current, and supplies the voltage to the discharge lamp 3.

The second lighting circuit 10 is a circuit for lighting the semiconductor light-emitting elements 5 of the second lamp units 2B; and in a state; e.g., in which a the switch 8 (the lighting switch) is closed, the circuit 10 receives a DC input voltage from the DC power supply 7, and supplies a stabilized output voltage to the semiconductor light-emitting elements 5. In the present exemplary embodiment, a common lighting circuit 10 is used for the plurality of the lamp units 2B, 2B, . . . .

When the switch 8 is closed, these lighting circuits start lighting of the respective lamp units (2A and 2B) substantially simultaneously. However, a period of time required for lighting the second lamp unit 2B is shorter than a period of time required for transitioning the discharge lamp 3 to a steady lighting state. This result is attributed to an instantaneous lighting property of the semiconductor light-emitting elements 5. Hence, when lighting of the first and second lamp units is started, the second lamp units 2B illuminate first, and thereafter the first lamp unit 2A transitions to the steady lighting state, at which point its brightness is stabilized.

Illumination light (see LB1 in FIG. 1) originating from the lamp unit 2A and illumination light (see LB2 in FIG. 1) are superimposed as illumination light illuminating forward of a vehicle. As a result, a low-beam light distribution whose boundary line between dark and bright zones is defined as a so-called cut-off line can be obtained.

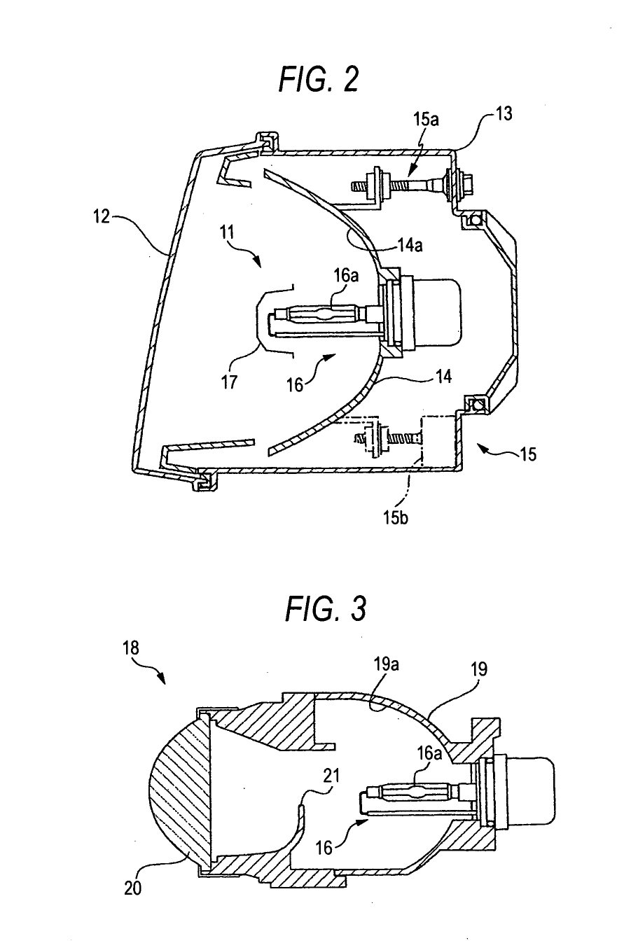

FIG. 2 illustrates an example configuration 11 of the first lamp unit 2A disposed in a lamp chamber.

A reflection mirror 14 is disposed in the lamp chamber, which includes a cover 12 formed from a transparent material and a lamp body 13 formed from a synthetic resin. The reflection mirror is attached to the lamp body 13 via an optical-axis adjustment mechanism (including respective support sections each of which forms a fulcrum, a lateral adjustment point, and a vertical adjustment point) 15. Meanwhile, the drawing illustrates a support section 15a, which partially forms the optical-axis adjustment mechanism 15, and a drive actuator 15b for use in vertical adjustment of the optical axis.

Examples of a reflection surface 14a of the reflection mirror 14 include a paraboloid of revolution, a free-form surface whose basic surface is a paraboloid of revolution, and a composite reflection surface formed by superimposing a plurality of small reflection surfaces (segments).

A metal halide lamp 16 (having, e.g., a luminous flux of 3,000 lm, a light intensity of about 12,000 cd/cm², and a color temperature falling within the range of 4,000 to 5,000 K), serving as a discharge lamp, is attached to the reflection mirror 14. A luminous center of an arc tube 16a of the metal halide lamp 16 is set to a focal point or a reference point of the reflection surface 14a. Meanwhile, a light-shielding member (a shade) 17 is disposed a short distance ahead of the metal halide lamp 16.

FIG. 3 illustrates another example of the first lamp unit 2A, showing an example configuration of a so-called projector-type lamp unit.

A lamp unit 18 has a reflection mirror 19 and a projection lens 20, with a shade (a light-shielding section) 21 therebetween.

Examples of a reflection surface 19a of the reflection mirror 14 include a spheroid and a free-form surface whose basic surface is a spheroid.

The metal halide lamp 16 is attached to the reflection mirror 19. The luminous center of the arc tube 16a of the metal halide lamp 16 is set to a focal point (a first focal point) or a reference point of the reflection surface 19a.

The shade 21 defines a boundary line between dark and bright zones, which is peculiar to a low beam, with a shape of its upper edge. Therefore, some of light reflected from the reflection mirror 19 passes through the projection lens 20 without being shielded by the shade 21, to thus be caused to exit forward.

As the projection lens 20, a plane-convex lens, or the like, is employed.

The reflection mirror 19, the shade 21, and the projection lens 20 are integrally coupled to thus form a unit. The unit is disposed in the lamp chamber demarcated with the lamp body and the transparent cover, although not illustrated, and supported on a lamp main body (the lamp body) by use of the optical-axis adjustment mechanism for vertical and lateral directions.

Meanwhile, the optical-axis adjustment mechanism is provided for adjustment and changing an illumination direction by means of changing the direction of the optical axis of each of the lamp units within a horizontal plane or a vertical plane. Example configurations of the optical-axis adjustment mechanism include a configuration of providing an optical-axis adjustment mechanism for each of the lamp units, and that of providing a common optical-axis adjustment mechanism for a plurality of lamp units.

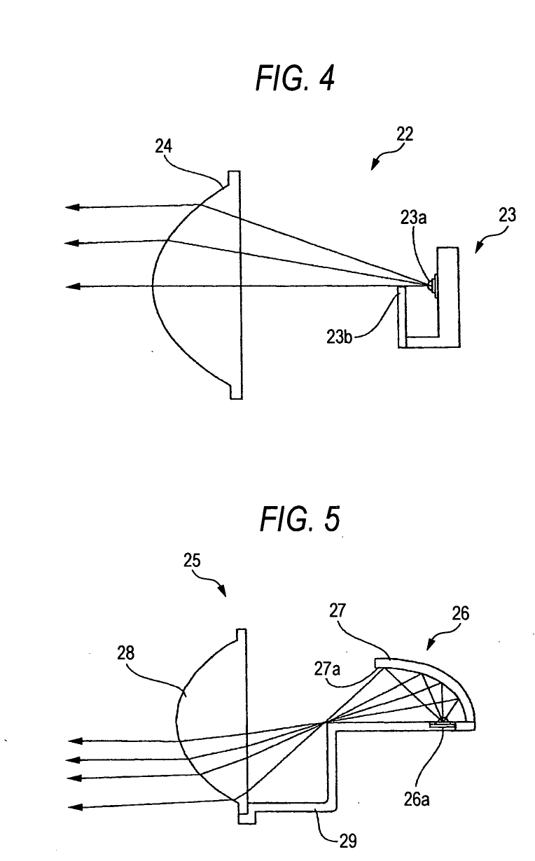

FIGS. 4 to 7 illustrate example configurations of the second lamp unit 2B.

Examples of a mode for forming a focusing illumination pattern which illuminates toward a distant range ahead of the own vehicle include the following:
a direct light type which uses solely a lens as an optical member (see FIG. 4); and
a reflection light type which uses a reflection mirror and a lens as optical members (see FIG. 5).

FIG. 4 is a view schematically illustrating a vertical cross-section of an example configuration of a lamp unit 22 which utilizes direct light emitted from alight-emitting diode.

A white light-emitting diode (LED) 23a (having, e.g., a luminous flux per chip is about 100 lm, a light intensity of about 2,000 cd/cm², and a color temperature falling within the range of 4,000 to 6,500 K) is employed in a light source section 23. Either a single LED chip per unit or two or more LED chips per unit can be employed.

A light-shielding section 23b is disposed in front of the light-emitting diode 23a; and a projection lens 24 is located at a position a predetermined distance further in front thereof.

When a low beam is to be illuminated, the light-emitting diode 23a is lit, and some of white light emitted therefrom passes through the projection lens 24, to thus be caused to exit to the outside.

FIG. 5 is a view illustrating a vertical cross-section of an example configuration of a lamp unit 25 which utilizes light emitted from a light-emitting diode and thereafter reflected from a reflection mirror.

A white light-emitting diode 26a is employed in a light source section 26 with a light-emitting section thereof located at a position at or close to a focal point of a reflection surface 27a of a reflection mirror 27.

A projection lens 28 is disposed ahead of the light source section 26, and a rear focal point thereof is set to the vicinity of the convergence point of reflected light. The projection lens 28 and the light source section 26 are attached to a support member 29, to thus be supported thereon. The support member 29 has, for example, a crank-like cross-sectional profile; and the reflection mirror 27 is fixed to the support member 29 at a portion close to a rear end, and the projection lens 28 is fixed to the same at a portion close to a front end.

During illumination of a low beam, light emitted from the light-emitting diode 26a is reflected from the reflection surface 27a (e.g., a spheroid), to thus be converged, and thereafter, the light passes through the projection lens 28, and is caused to exit to the outside.

Example configurations for forming a pattern diffused in the horizontal direction, so as to primarily illuminate a near range or a medium range ahead of the vehicle, include employing a diffusing surface formed by: providing projections and depressions on a cylindrical curved surface, a hyperboloid, or a basic reflection surface; a free-form surface; or a composite reflection surface.

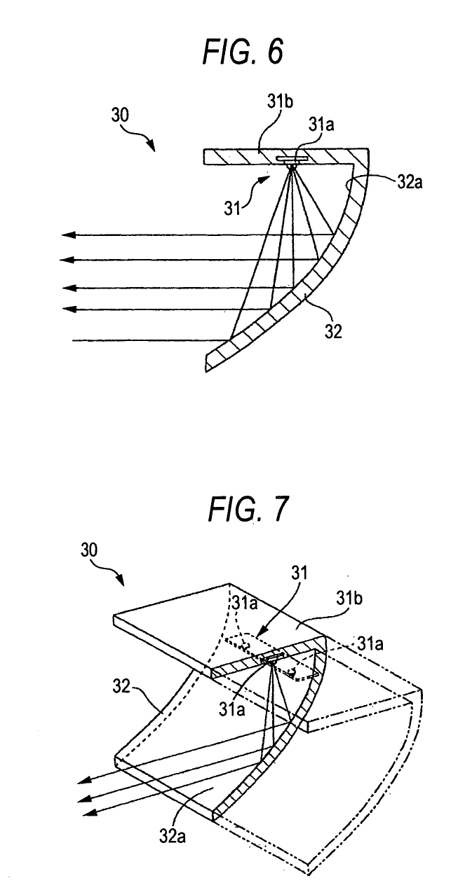

FIGS. 6 and 7 schematically illustrate an example of a lamp unit 30, which utilizes light emitted from a light-emitting diode and thereafter reflected from a reflection mirror (a reflection mirror of a cylindrical curved surface). FIG. 6 shows a vertical cross-section of the configuration, and FIG. 7 is a perspective view.

A white light-emitting diode 31a is employed in a light source section 31. In the present embodiment, the light source section 31 is attached to a support section 31b in a downwardly-oriented state.

A reflection surface 32a of the reflection mirror 32 has a cylindrical shape. For example, the reflection surface can be a cylindrical curved surface whose vertical cross-section forms a parabola and which is formed as a movement locus when the parabola is moved in a horizontal direction. Light-emitting sections of one or more light-emitting diodes 31a are located at a focal point of the parabola (on a local line of the cylindrical curved surface). During illumination of a low beam, light emitted from the diode(s) is reflected from the reflection surface 32a. At this time, the reflected light is directed to exit to the outside in the form of a light beam parallel with the optical axis within the vertical plane including the optical axis, and is diffused to the right and left on the horizontal plane including the optical axis.

Meanwhile, the light having exited from the respective lamp units passes through an unillustrated cover, and is caused to illuminate the outside of the lamp. In addition, an optical-axis adjustment mechanism is provided for each of the respective lamp units, or as a common mechanism for the same.

Examples of this exemplary embodiment include a configuration employing only one unit of each of the respective types and a configuration combining a plurality of units of each of the respective types. When a configuration combining a plurality of units is adopted, a desired light distribution performance can be obtained.

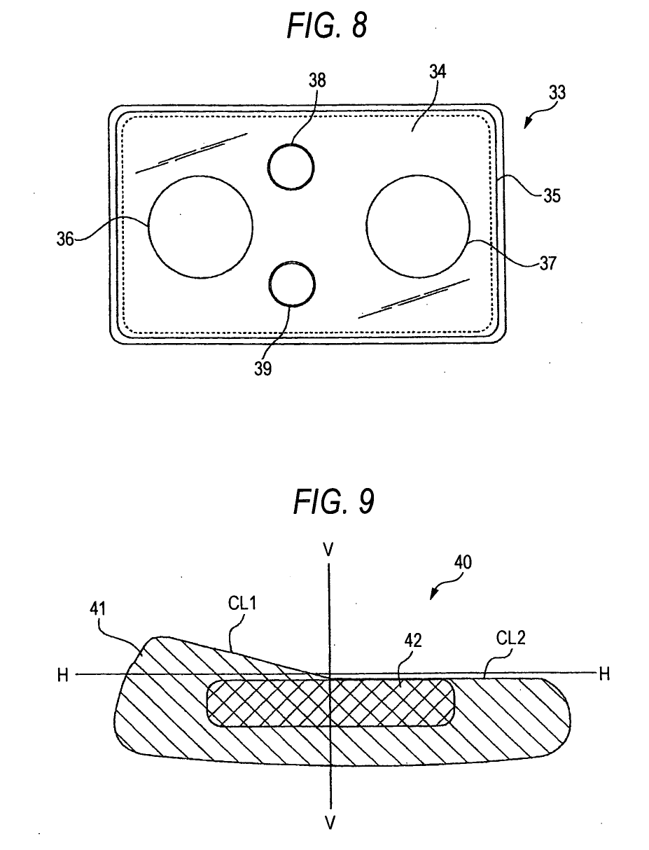

FIGS. 8 and 9 illustrate an example application of the exemplary embodiment of the invention as a vehicle headlamp. FIG. 8 is a front view, and FIG. 9 is a view schematically illustrating a low-beam light distribution pattern.

A vehicle headlamp 33 has a plurality of lamp units 36 through 39 in a lamp chamber demarcated by a transparent cover 34 and a lamp body 35.

The lamp unit 36 employs a discharge lamp as a light source (see FIGS. 2 and 3), and is lit when a low beam is to be illuminated.

The lamp unit 37 is lit when a high beam is to be illuminated. The light source of the lamp unit 37 is not limited by type and may be, for example, an incandescent lamp, a discharge lamp, a light-emitting element, or the like.

The lamp units 38 and 39 are disposed between the lamp units 36 and 37. Each of the lamp units 38 and 39 employs a light-emitting diode as a light source. The lamp units 38 and 39 are lit when the low beam is to be illuminated. More specifically, the lamp unit 38 is located at an upper portion, and the lamp unit 39 is located at a lower portion; and each of the lamp units 38 and 39 has a configuration for forming a focusing illumination pattern (see FIGS. 4 and 5).

FIG. 9 depicts a light distribution pattern 40 of low-beam illumination light, where a line H-H denotes a horizontal line, and a line V-V denotes a vertical line.

A pattern 41 depicts an illumination pattern formed when the lamp unit 36 is lit. A line CL1 indicates a cut-off line, which is on a side of the vehicle's own lane, and which is tilted by a predetermined angle in relation to the line H-H. A line CL2 indicates a cut-off line, which extends parallel with the line H-H on a side closer to an opposing lane, and which is located slightly below the line H-H. The pattern 41 is horizontally-diffused in its entire range.

In contrast thereto, a pattern 42 depicts an illumination pattern formed when the lamp units 38 and 39 are lit, and mainly illuminates toward a distant range ahead of the vehicle. More specifically, the pattern 42 contributes to formation of a center of the light intensity (a so-called hot zone) of the light distribution pattern 40, as well as to a center portion of the pattern 41. Meanwhile, the lamp units 38 and 39 are set or adjusted so that an optical axis of each of the lamp units 38 and 39 is oriented slightly downward as compared with the line H-H.

As described above, when a low beam is to be illuminated, lighting of the lamp units 36, 38, and 39 is started simultaneously, thereby obtaining a light distribution (a dipped-beam light distribution) in which the patterns 41 and 42 are superimposed.

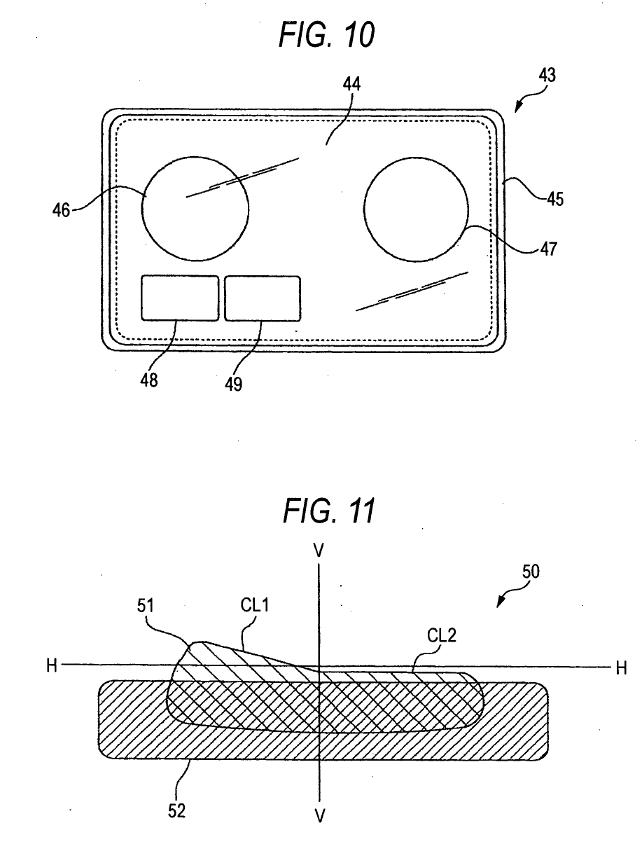

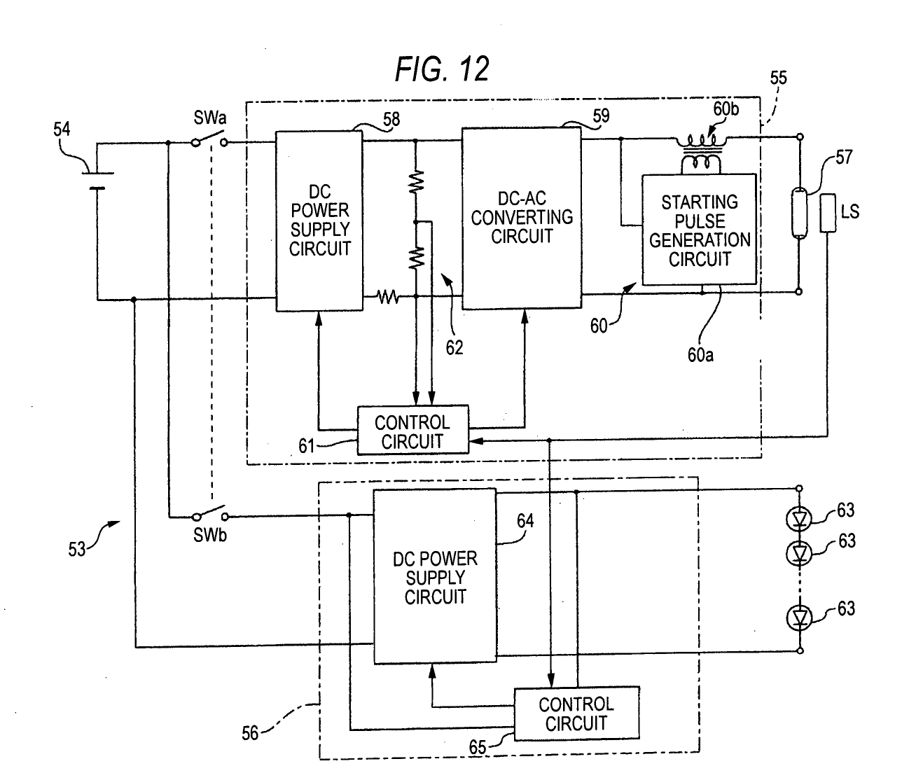

FIGS. 10 and 11 illustrate another example application of the exemplary embodiment of the invention as a vehicle headlamp. FIG. 10 is a front view, and FIG. 11 is a view schematically illustrating a low-beam light distribution pattern.

A vehicle headlamp 43 has a plurality of lamp units 46 through 49 in a lamp chamber demarcated by a transparent cover 44 and a lamp body 45.

The lamp unit 46 is configured while employing a discharge lamp as a light source (see FIGS. 2 and 3), and is lit when a low beam is to be illuminated.

The lamp unit 47 is lit when a high beam is to be illuminated. A light source of the lamp unit 47 may be of an arbitrary type.

The lamp units 48 and 49 are disposed below the lamp unit 46. Each of the lamp units 48 and 49 employs a light-emitting diode as a light source. The lamp units 48 and 49 are lit when the low beam is to be illuminated. Each of the lamp units 48 and 49 has a configuration for forming a horizontally-diffusing illumination pattern (see FIGS. 6 and 7).

FIG. 11 depicts a light distribution pattern 50 of low-beam illumination light (descriptions of the line H-H and the line V-V have already been provided).

A pattern 51 depicts an illumination pattern formed when the lamp unit 46 is lit. As described above, CL1 and CL2 indicate cut-off lines peculiar to a low beam.

A pattern 52 depicts an illumination pattern which is formed when the lamp units 48 and 49 are lit, and which is horizontally diffused as compared with the pattern 51. The pattern 52 is illuminated over a near range and a medium range ahead of the vehicle. Meanwhile, the lamp units 48 and 49 are set or adjusted so that an optical axis of each of the lamp units is oriented slightly downward as compared with the line H-H.

As described above, when a low beam is to be illuminated, lighting of the lamp units 46, 48, and 49 is started simultaneously, thereby obtaining a light distribution (a dipped-beam light distribution) in which the patterns 51 and 52 are superimposed.

As described above, light emitted from the lamp unit that employs a discharge lamp and light emitted from the lamp units that employ semiconductor light-emitting elements are illuminated toward a distant range ahead of the vehicle. That is, the lamp unit which employs a discharge lamp having high intensity and luminous energy is effective for formation of a focusing pattern within a low-beam light distribution pattern, which irradiates a distant range ahead of a vehicle.

The lamp units employing semiconductor light-emitting elements are effective for formation of a diffusion pattern, which is diffused in a horizontal direction within a low-beam light distribution pattern. As illustrated in FIGS. 10 and 11, it is preferable to use a configuration in which light emitted from the lamp unit, which employs a discharge lamp, primarily irradiates a region including the distant range ahead of the vehicle; and light emitted from the lamp units, which employ semiconductor light-emitting elements, is diffused in the horizontal direction. Alternatively, a configuration in which light emitted from the lamp unit, which employs a discharge lamp, and light emitted from the lamp unit, which employs a semiconductor light-emitting element, are illuminated while being diffused in the horizontal direction can also be used. As described above, a lamp unit employing a discharge lamp as a light source is used for primarily formation of a focusing pattern, by virtue of the discharge lamp's high intensity; and a lamp unit employing a light-emitting diode as a light source is used primarily for formation of a diffusion pattern which is diffused in the horizontal direction. By means of superimposing both patterns, a desired low-beam distribution pattern can be obtained.

FIG. 12 is a view illustrating an example 53 of a lighting circuit which constitutes a vehicle headlamp.

In the present example, a DC power voltage is supplied to a lighting circuit 55 from a DC power supply 54 by way of a switch SWa, and a DC power voltage is supplied to a lighting circuit 56 from the DC power supply 54 by way of a switch SWb. Meanwhile, the respective switches SWa and SWb are switches (lighting switches) which are closed when lighting the first lamp unit and the second lamp unit is to be started, and which are closed in synchronization. However, the invention is not limited thereto, and a configuration in which solely a single lighting switch is disposed for common use by the lighting circuits 55 and 56, thereby enabling power supply and power off of both circuits simultaneously, can also be used.

The lighting circuit 55 is a circuit for lighting a discharge lamp 57 (corresponding to the light source of the first lamp unit in the appended claims) when a low beam is to be illuminated. The lighting circuit 55 has, for instance, a DC power supply circuit 58, a DC-AC converting circuit 59, a starting circuit 60, and a control circuit 61.

The DC voltage input from the DC power supply 54 by way of the switch SWa is supplied to the DC power supply circuit 58, and converted to a desired voltage. The DC power supply circuit 58 has, for example, a configuration of a switching regulator including a semiconductor switching element, and a DC-DC converter of a chopper type, a flyback type, or the like, employed therein. An output voltage to be output from the DC power supply circuit 58 is controlled upon receipt of a control signal supplied from the control circuit 61.

The DC-AC converting circuit 59 is disposed at a stage subsequent to the DC power supply circuit 58, and performs conversion into an AC upon receipt of the DC input voltage from the DC power supply circuit 58. The DC-AC converting circuit 59 has, for example, a full bridge circuit including use of two pairs of semiconductor switching elements, and a drive circuit therefor; and outputs a rectangular voltage to the discharge lamp 57.

The starting circuit 60 is provided for supplying a starting signal to the discharge lamp 57. For instance, an output from a starting-pulse generation circuit 60a is boosted by a transformer 60b; and the thus-boosted output is superimposed on an AC voltage, and applied to the discharge lamp 57.

The control circuit 61 is a circuit for controlling input power to the discharge lamp 57, as well as for detecting an abnormal condition of the discharge lamp and/or the circuits, to thus provide a safety measure. The control circuit 61 is supplied with, for example, signals from a detection section 62, which is provided for detection of the output voltage and the output electric current from the DC power supply circuit 58. The control circuit 61 sends a control signal to the DC power supply circuit 58 to thus control the output voltage therefrom, and sends a control signal to the DC-AC converting circuit 59 to thus perform driving control thereof. However, the control circuit 61 does not perform control for expediting light emission of the discharge lamp during a transient period from a point in time when lighting of the discharge lamp 57 is started until the discharge lamp has transitioned to a steady lighting state. More specifically, a temporary input of excessive power for the purpose of reducing a starting time of the discharge time is obviated, and the input power value to the discharge lamp during the transient period is made the rated power value or lower, or a power value to be supplied under the steady lighting state or lower.

Meanwhile, an optical sensor LS is provided in the configuration for detecting the luminous energy or a change in the luminous energy. A signal detected by the optical sensor LS is sent to the control circuit 61 or to (a control circuit of) the lighting circuit 56. Alternatively, a configuration that does not include use of the DC-AC converting circuit can also be applied to the exemplary embodiment of the invention.

The lighting circuit 56 is a circuit for lighting semiconductor light-emitting elements 63, 63, . . . (corresponding to the light source of the second lamp unit) upon receipt of the DC input voltage from the DC power supply 54 by way of the switch SWb.

A DC power supply circuit 64 is an element which supplies the DC voltage to the semiconductor light-emitting elements 63, 63, . . . , and is controlled through receipt of a signal supplied from a control circuit 65.

The control circuit 65 detects an output voltage, a DC input voltage, and the like, with regard to the DC power supply circuit 64, and performs control operations, such as constant current control related to the DC power supply circuit 64 and control over dimming of the semiconductor light-emitting elements 63. In addition, the control circuit 65 has a function of, in relation to the semiconductor light-emitting elements 63, discriminating non-illumination, protecting circuits, and the like. Meanwhile, in a mode in which a detection signal output from the optical sensor LS is sent to the control circuit 65, dimming of the semiconductor light-emitting elements 63 can be controlled in accordance with the brightness of the discharge lamp 57 (for instance, the light-emitting elements are caused to be bright during a period from a point in time when lighting of the discharge lamp is started until the luminous flux of the discharge lamp attains a predetermined value to thus be stabilized; and, after the brightness of the discharge lamp has stabilized, dimming is performed).

The present exemplary embodiment has described the configuration in which the plurality of semiconductor light-emitting elements 63, 63, . . . are connected in series, and are provided with the output voltage from the DC power supply circuit 64. However, a configuration in which the semiconductor light-emitting elements are connected in parallel is also possible.

In addition, in the configuration illustrated in FIG. 8 or 10, the respective lamp units are disposed in a single lamp chamber. However, the invention is not limited thereto, and another configuration in which the respective lamp units are placed at different locations at the front of a vehicle.

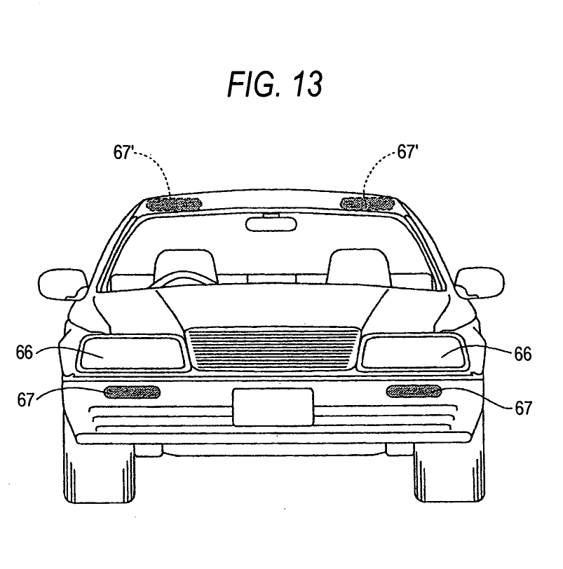

Examples of the this include a configuration in which, as illustrated in FIG. 13, headlamps 66, 66, each of which includes a lamp unit employing a discharge lamp, are disposed at the front of a vehicle; and lamp units 67, 67, each of which employs a light-emitting element (or lamps 67, 67 including the lamp unit) are disposed slightly below the headlamps 66, 66. Alternatively, when lamp units 67′, 67′ each of which employs a light-emitting element (or lamps 67′, 67′ including the lamp units) are provided at elevated positions at the front of the vehicle as indicated by a short dashes line in the drawing, there can be provided a glare-preventing countermeasure, or the like.

In such a configuration, when, e.g., the switches SWa and SWb illustrated in FIG. 12 are closed, the output voltage from the lighting circuit 55 is supplied to the discharge lamps of the headlamps 66. Upon this supply, lighting of the lamp units employing the discharge lamps is started. In conjunction therewith, the output voltage from the lighting circuit 55 is supplied to the semiconductor light-emitting elements 63. Upon supply to the semiconductor light emitting elements 63, lighting of the lamp units or the lamps 67 (or 67′), including lamp units disposed at other positions apart from the headlamps 66, is started.

Next will be described the input power, build-up characteristics of the luminous flux, and a change in the luminous flux maintaining ratio at an early stage (i.e., a transient period) of the discharge lamp in which the input power exceeds the rated power value during the transient period compared with a discharge lamp of the exemplary embodiment.

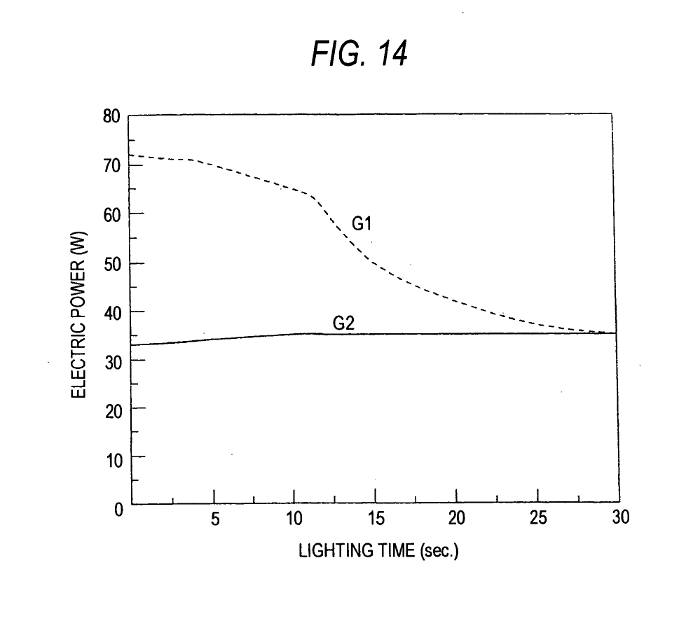

FIG. 14 is a graph showing an example of a change of the input power with respect to time. The X axis represents a lighting time (unit: second) whose origin is set to the point in time when lighting is started, and the Y axis represents electric power (unit: W) supplied to the discharge lamp (rated power value: 35 W). Meanwhile, a short-dash line G1 of the graph indicates a state, during the transient period from the point in time when lighting of the discharge lamp is started until the discharge lamp has transitioned to the steady lighting state, in which, after having undergone power control for exceeding the rated power value by a significant margin, the input power gradually approaches the rated power value. In addition, the solid line G2 of the graph indicates a state in which the input power does not exceed the rated power value during the transient period without performing such a power control as described above.

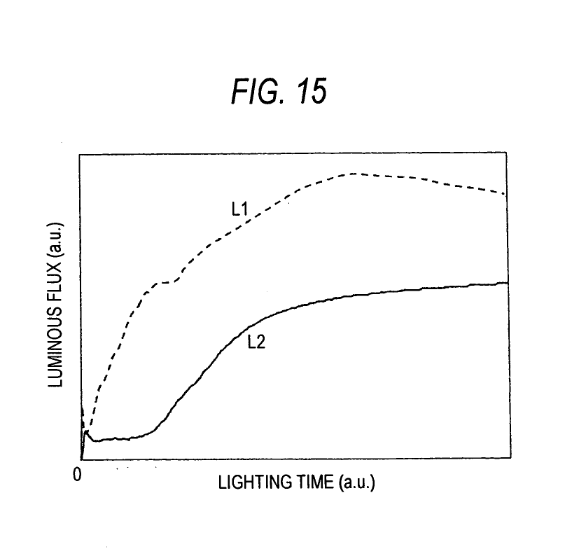

FIG. 15 is a graph illustrating an example of a build-up change in the luminous flux. The X axis represents an lighting time (arbitrary unit) whose origin is set to the point in time when lighting is started, and the Y axis represents the luminous flux (arbitrary unit) of the discharge lamp (rated power value: 35 W) Meanwhile, a short-dash line L1 in the drawing indicates the change in luminous flux, in which, after having undergone power control for exceeding the rated power value by a significant margin, the input power gradually approaches the rated power value during the transient period from the point in time when lighting of the discharge lamp is started until the discharge lamp has transitioned to the steady lighting state. In addition, the solid line L2 in the graph indicates the change in the luminous flux in a case to which no such power control is performed.

As is apparent from the differences between the input power control operations during the transient period, the line L1 of the graph immediately converges to the rated luminous flux value after overshooting. In contrast, the line L2 of the graph indicates that the luminous flux is slow in build-up, thereby taking some time before reaching the rated value.

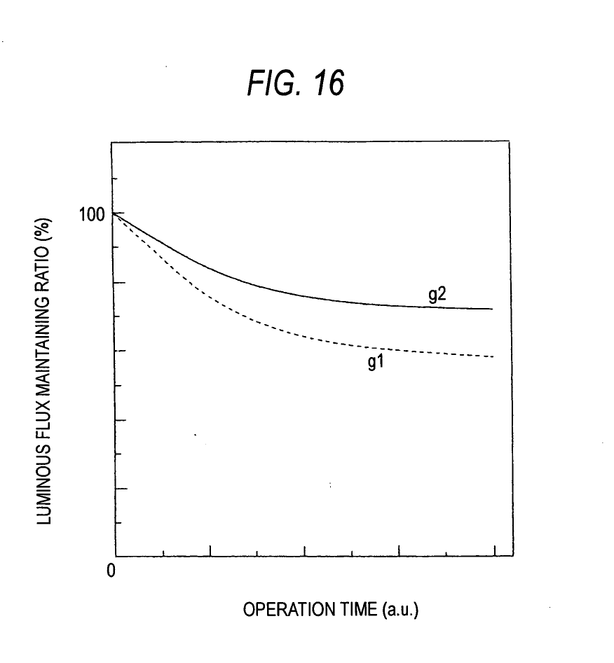

FIG. 16 is a graph illustrating an example, where the X axis represents operation time (arbitrary unit) with the origin being set to a point in time when the discharge lamp is used for the first time, and the Y axis represents a luminous flux maintaining ratio (a relative value with the initial value assumed to be 100) of the discharge lamp. Meanwhile, a short-dash line g1 of the graph indicates a case where, during the transient period from the point in time when lighting of the discharge lamp is started until the discharge lamp has transitioned to the steady lighting state, the input power is controlled so as to exceed the rated power value by a significant margin at all times. In addition, the solid line g2 of the graph indicates a case to which no such power control is performed.

As is apparent from comparison between the two lines, the luminous flux maintaining ratio of the line g1 in the graph decreases with increasing operation time, thereby increasing the difference between the lines g1 and g2.

As described above, when excessive input power is not required at the early stage in the lighting of the discharge lamp, in view of influences exerted on the useful life of the discharge lamp, or the like, a decrease in the luminous flux maintaining ratio can be suppressed, thereby prolonging operation time. Alternatively, when a configuration in which control is performed within a range where the power value is lower than the rated power of the discharge lamp (that is, constant power control on the basis of α·Pc, where a coefficient parameter is denoted as α (0<α<1, e.g., α≈0.7), and the rated power is denoted as Pc) is used, favorable working effects can be yielded in view of the influences, such as the useful life, degradation, and the like, of the discharge lamp.

The feature of not requiring high power in transient control of the discharge lamp is advantageous in view of simplification of the circuit configuration and reduced cost. For instance, in FIG. 12, an increase in the size of the DC power supply circuit 58 and an increase in cost become significant with increasing input power. Therefore, when the input power to be supplied to the discharge lamp during the transient period can be suppressed, components that are inexpensive and subjected to less severe requirements, in view of pressure resistance, heat resistance, and the like, can be used. In addition, contribution to miniaturization and reduction in size can be obtained. In addition, the configuration of the control circuit is simplified (the configuration portion for use in transient power control for use in reduction of the starting time becomes unnecessary). Hence, e.g., in a mode where the control circuit is mounted as an LSI chip, the invention is effective for miniaturization of the LSI chip, and can reduce the number of elements and peripheral devices to be used in the chip.

According to the above-described configuration, in a vehicle headlamp in which a lamp unit employing a discharge lamp, and lamp units employing semiconductor light-emitting elements are superimposed, a luminous flux provided by the semiconductor light-emitting elements is built up immediately after start of lighting, thereby ensuring a minimum level luminous energy and light distribution; and thereafter, at a point in time when a lighting state of the discharge lamp is stabilized, illumination patterns formed by the respective lamp units are superimposed, thereby obtaining a low-beam light distribution.

Accordingly, in application to a vehicle headlamp, or the like, the following various advantages are yielded.
The configuration of a lighting circuit of a discharge lamp is simplified, which contributes to cost reduction.
Since loads applied on the discharge are reduced, the usable lives of light-emitting diodes are prolonged, and, accordingly, usable life of the entire lamp system is prolonged.
Since the light-emitting diodes have a color temperature close to that of the discharge lamp, even when a light distribution pattern is formed by means of superimposing the light of the light-emitting diode and that of the discharge lamp, there is provided a less unnatural sensation.
The feature of the discharge lamp of being slow in build-up is complemented through utilization of instantaneous lighting of the light-emitting diodes. In addition, miniaturization of the entire lamp can be attained by virtue of employment of the light-emitting diodes.
Illumination light patterns originating from the light-emitting diodes are used for formation of a light distribution pattern at all times (since the light-emitting diodes are not employed as a temporary substituent light source, a utilization ratio of the light source becomes high).

That is, the present exemplary embodiment of the invention, whose attention is focused on instantaneous lighting of a semiconductor light-emitting element, can prevent shortage in luminous energy during a transient period until a lighting state of a discharge lamp is stabilized. In addition, the exemplary embodiment of the invention obviates control of temporarily inputting excessive power to the discharge lamp immediately after startup thereof to thus rapidly stabilize the discharge lamp. Therefore, the exemplary embodiment of the invention is effective for simplification of the circuit configuration, prevention of degradation of the discharge lamp, and the like. The invention also contributes to a cost reduction through simplification of a bulb in terms of structure, relaxation of specifications, and the like. Furthermore, employment of a semiconductor light-emitting element is effective for miniaturization of the entire lamp.

The first lamp unit employing a discharge lamp which is high in intensity and luminous energy is effective for formation of a focusing pattern, in a low-beam light distribution pattern, which illuminates a distant range ahead of a vehicle. More specifically, light emitted from the first lamp unit during illumination thereof, or light emitted from the first lamp unit and the second lamp unit during illumination thereof, is preferably caused to illuminate toward the distant range ahead of the vehicle. For instance, in a configuration mode in which light emitted from the first lamp unit during illumination thereof is primarily caused to illuminate toward the distant range ahead of the vehicle, light emitted from the second lamp unit during illumination thereof is caused to illuminate while being diffused in the horizontal direction (the lamp unit employing a semiconductor light-emitting element is effective for formation of a diffusion pattern which is diffused in the horizontal direction, in a low-beam light distribution pattern.)

The configuration having a switch which is closed when lighting of the first and second lamp units is started; a first lighting circuit for lighting the discharge lamp upon receipt of a DC input voltage; and a second lighting circuit for lighting said semiconductor light-emitting element upon receipt of a DC input voltage, and configured such that, when the switch is closed, an output voltage from the first lighting circuit is supplied to the discharge lamp, whereby lighting of the first lamp unit disposed at the front of a vehicle is started, and, in conjunction therewith, an output voltage from the second lighting circuit is supplied to the semiconductor light-emitting element, whereby lighting of the second lamp unit disposed at the front of the vehicle at a location different from the first lamp unit is started, provides miniaturization of the second lamp unit including use of the semiconductor light-emitting element. In addition, since the lamp units can be arranged freely with regard to locations, there is obtained a high degree of flexibility in terms of vehicle design (for instance, there can be selected locations which contribute to reduction of air resistance or effective for prevention against glare).

When a control for causing, during a transient period from a point in time when lighting of the discharge lamp is started until the discharge lamp has transitioned to a steady lighting state, an input power value to the discharge lamp is controlled to a rated power value or lower, or a power value to be supplied under the steady lighting state or lower in a configuration in which a lighting circuit of the discharge lamp has a starting circuit for supplying to the discharge lamp a starting signal, and a control circuit for controlling input power to the discharge lamp, advantages of reducing a load, or the like, are yielded. More specifically, the load applied during a transient power control period for reduction of a starting time of the discharge lamp is reduced. As a result, influences on the useful life or the like disappear, or are attenuated. In addition, the lighting circuit of the discharge lamp is simplified, or technical requirements for the structure and/or specifications of the discharge lamp are relaxed, which is advantageous for cost reduction, and the like.

In a case when a white light-emitting diode is employed as the semiconductor light-emitting diode, preferably, a color temperature of the white light-emitting diode falls within a range of 4,000 to 6,500 K; and a color temperature of the discharge lamp falls within a range of 4,000 to 6,500 K. Thus, in the configuration employing the white light-emitting diode, the color temperature thereof is close to that of the discharge lamp. Accordingly, a composite pattern which provides a less unnatural sensation can be obtained. In addition, as compared with an incandescent lamp, a light-emitting diode has a long useful life. Therefore, the usable time of the entire lamp including the usable life of the discharge lamp can be prolonged (the replacement frequency of a light source, and the like, can be reduced)

While the invention has been described with reference to the exemplary embodiment, the technical scope of the invention is not restricted to the description of the exemplary embodiment. It is apparent to the skilled in the art that various changes or improvements can be made. It is apparent from the description of claims that the changed or improved configurations can also be included in the technical scope of the invention.

What is claimed is:

1. A vehicle headlamp, comprising:
a first lamp unit comprising a discharge lamp as a light source, and
a second lamp unit comprising a semiconductor light-emitting element as a light source,
wherein illumination light patterns originating from said respective lamp units are superimposed so as to obtain a low-beam light distribution.

2. The vehicle headlamp defined in claim 1, wherein light emitted from said first lamp unit and light emitted from said second lamp unit are illuminated toward a distant range ahead of said vehicle.

3. The vehicle headlamp defined in claim 1, further comprising:
a switch, which is closed when lighting of said first and second lamp units is started;
a first lighting circuit for lighting said discharge lamp upon receipt of a DC input voltage; and
a second lighting circuit for lighting said semiconductor light-emitting element upon receipt of a DC input voltage, wherein,
when said switch is closed, an output voltage from said first lighting circuit is supplied to said discharge lamp, whereby lighting of said first lamp unit disposed at the front of a vehicle is started, and, in conjunction therewith, an output voltage from said second lighting circuit is supplied to said semiconductor light-emitting element, whereby lighting of said second lamp unit is started, said second lamp unit being disposed at the front of said vehicle at a location different from said first lamp unit.

4. The vehicle headlamp defined in claim 1, wherein a lighting circuit of said discharge lamp comprises:
a starting circuit for supplying to said discharge lamp a starting signal, and
a control circuit for controlling input power to said discharge lamp; and,
wherein during a transient period from a point in time when lighting of said discharge lamp is started until said discharge lamp has transitioned to a steady lighting state, an input power value to said discharge lamp is a rated power value or lower, or is a power value to be supplied under said steady lighting state or lower.

5. The vehicle headlamp defined in claim 1, wherein:
said semiconductor light-emitting element comprises a white light-emitting diode whose color temperature falls within a range of 4,000 to 6,500 K; and
a color temperature of said discharge lamp falls within a range of 4,000 to 6,500 K.

6. The vehicle headlamp defined in claim 2, further comprising:
a switch, which is closed when lighting of said first and second lamp units is started;
a first lighting circuit for lighting said discharge lamp upon receipt of a DC input voltage; and
a second lighting circuit for lighting said semiconductor light-emitting element upon receipt of a DC input voltage, wherein,
when said switch is closed, an output voltage from said first lighting circuit is supplied to said discharge lamp, whereby lighting of said first lamp unit disposed at the front of a vehicle is started, and, in conjunction therewith, an output voltage from said second lighting circuit is supplied to said semiconductor light-emitting element, whereby lighting of said second lamp unit is started, said second lamp unit being disposed at the front of said vehicle at a location different from said first lamp unit.

7. The vehicle headlamp defined in claim 2, wherein a lighting circuit of said discharge lamp comprises:
a starting circuit for supplying to said discharge lamp a starting signal, and
a control circuit for controlling input power to said discharge lamp; and,
wherein during a transient period from a point in time when lighting of said discharge lamp is started until said discharge lamp has transitioned to a steady lighting state, an input power value to said discharge lamp is a rated power value or lower, or is a power value to be supplied under said steady lighting state or lower.

8. The vehicle headlamp defined in claim 2, wherein
said semiconductor light-emitting element comprises a white light-emitting diode whose color temperature falls within a range of 4,000 to 6,500 K; and
a color temperature of said discharge lamp falls within a range of 4,000 to 6,500 K.

9. The vehicle headlamp defined in claim 3, wherein
said semiconductor light-emitting element comprises a white light-emitting diode whose color temperature falls within a range of 4,000 to 6,500 K; and
a color temperature of said discharge lamp falls within a range of 4,000 to 6,500 K.

10. The vehicle headlamp defined in claim 6, wherein
said semiconductor light-emitting element comprises a white light-emitting diode whose color temperature falls within a range of 4,000 to 6,500 K; and
a color temperature of said discharge lamp falls within a range of 4,000 to 6,500 K.

11. The vehicle headlamp defined in claim 1, further comprising control circuitry that simultaneously illuminates said discharge lamp and said semiconductor light emitting element, wherein a period of time required for lighting said vehicle headlamp is shorter than a period of time until said discharge lamp has transitioned to a steady lighting state.
